(19) United States
(12) Patent Application Publication
(10) Pub. No.: US 2004/0020292 A1
(43) Pub. Date: Feb. 5, 2004

(54) Single chip piezoelectric triaxial MEMS accelerometer

(76) Inventor: Ken Kan Deng, North Potomac, MD (US)

Correspondence Address: BLANK ROME LLP, 600 NEW HAMPSHIRE AVENUE, N.W., WASHINGTON, DC, 20037, US

(21) Appl. No.: 10/417,154

(22) Filed: Apr. 17, 2003

Related U.S. Application Data
(60) Provisional application No. 60/372,783, filed on Apr. 17, 2002.

(51) Int. Cl. G01P 15/09

(52) U.S. Cl. 73/514.34; 29/595; 29/25.35

(57) ABSTRACT

The present invention is directed to a sensing structure comprising four components: a central block proof mass, a continuous belt-shaped membrane (or one having another suitable shape), a piezoelectric sensing layer placed on top of the membrane, and a fixed mounting frame. Electrodes are attached to the top and the underside of the piezoelectric sensing layer. The structure results in an axisymmetric stress distribution.

### RELATED APPLICATION

This application is a nonprovisional application claiming priority from provisional application No. 60/372,783, filed Apr. 17, 2002, the full disclosure of which is incorporated by reference herein.

### FIELD OF THE INVENTION

The present invention is directed to piezoelectric accelerometers and more particularly to a single-chip triaxial piezoelectric accelerometer using microelectromechanical system (MEMS) technology. The present invention is further directed to a method of making such an accelerometer.

### SUMMARY OF THE INVENTION

The present invention is directed to a sensing structure comprising four components: a central block proof mass, a continuous belt-shaped membrane (or one having another suitable shape), a piezoelectric sensing layer placed on top of the membrane, and a fixed mounting frame. Electrodes are attached to the top and the underside of the piezoelectric sensing layer. The structure results in an axisymmetric stress distribution.

The structure can be used in any suitable sensing arrangement. Two illustrative but not limiting possibilities are a triaxial sensor and a uniaxial sensor. In either sensor, the central block proof mass, reacting to an acceleration, applies a stress to the piezoelectric layer, resulting in a potential that is detected through the electrodes.

The present invention is further directed to a method of making such a structure using MEMS techniques. A bare layer of a suitable material, such as silicon (Si), is processed to form a buffer layer, and then electrode layers and a piezoelectric layer are deposited on the buffer layer. The resulting multi-layer structure is processed to pattern the electrodes, to sculpt the mass block and the circular shape membrane.

The invention is not limited to the preferred embodiment.

### BRIEF DESCRIPTION OF THE DRAWINGS

FIG. 1: 3D Cross-section drawings of the proposed triaxial MEMS sensing structure

FIG. 2: Triaxial sensor electrode layout

FIG. 3: Stress colored contour drawing due to a vertical Z acceleration

FIG. 4: Radial stress distribution due to a vertical Z acceleration

FIG. 5: Stress colored contour drawing due to a vertical X (or. Y) acceleration

FIG. 6: Radial stress distribution due to a vertical X (or. Y) acceleration

FIG. 7: Cross-section of sensing structure

FIG. 8: Detailed cross section of the circular membrane of the structure of FIG. 7

FIG. 9: Layout of a uniaxial accelerometer implemented with the structure of FIG. 7

### DETAILED DESCRIPTION OF THE PREFERRED EMBODIMENT

Preferred embodiments of the invention will now be set forth in detail with reference to the drawings, in which like reference numerals refer to like elements throughout.

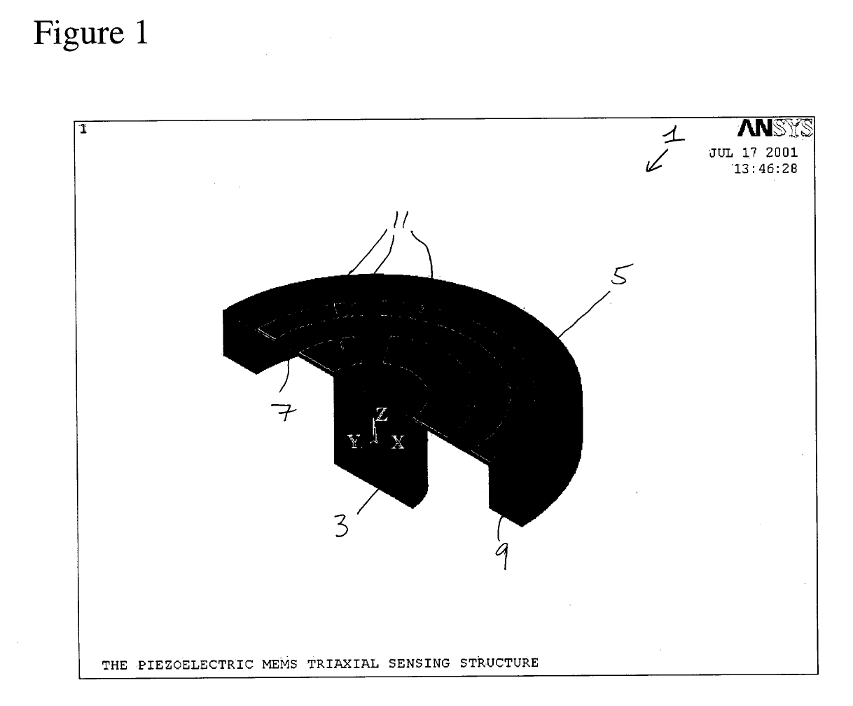

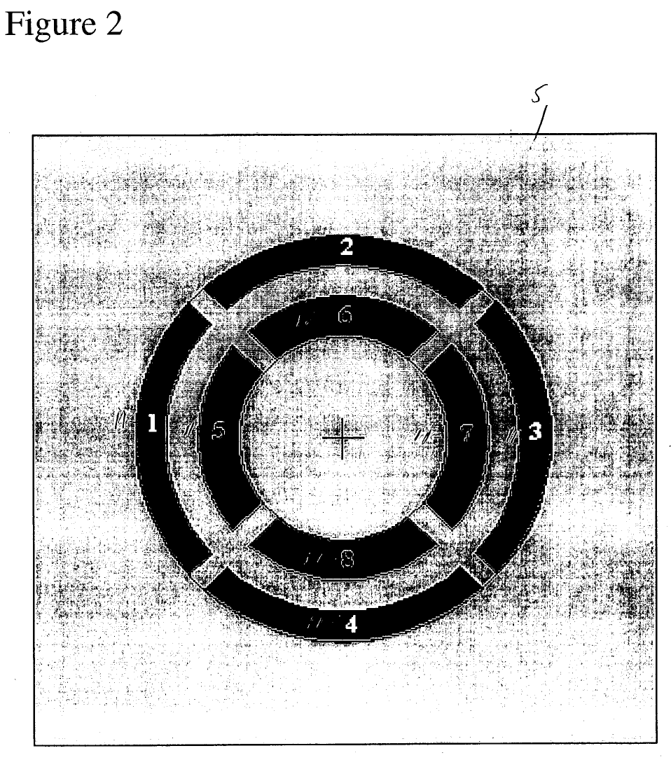

A circular membrane type sensing structure is shown in cross section in FIG. 1. Basically, this sensing structure 1 comprises four components: a central block proof mass 3, a continuous belt shape membrane 5, a piezoelectric film or sensing layer 7 placed on the top of the membrane 5, and a fixed mounting frame 9. Moreover, underneath the piezoelectric layer 7, a solid electrode is deposited (not shown in FIG. 1, but will be described below); and, on top of the piezoelectric film 7, eight (8) electrode pads 11 are arranged concentrically around the proof mass 3 and located near both ends of the circular membrane 5. This top electrode pattern is illustrated in FIG. 2, showing eight electrodes 11-1, 11-2, 11-3, 11-4, 11-5, 11-6, 11-7, 11-8.

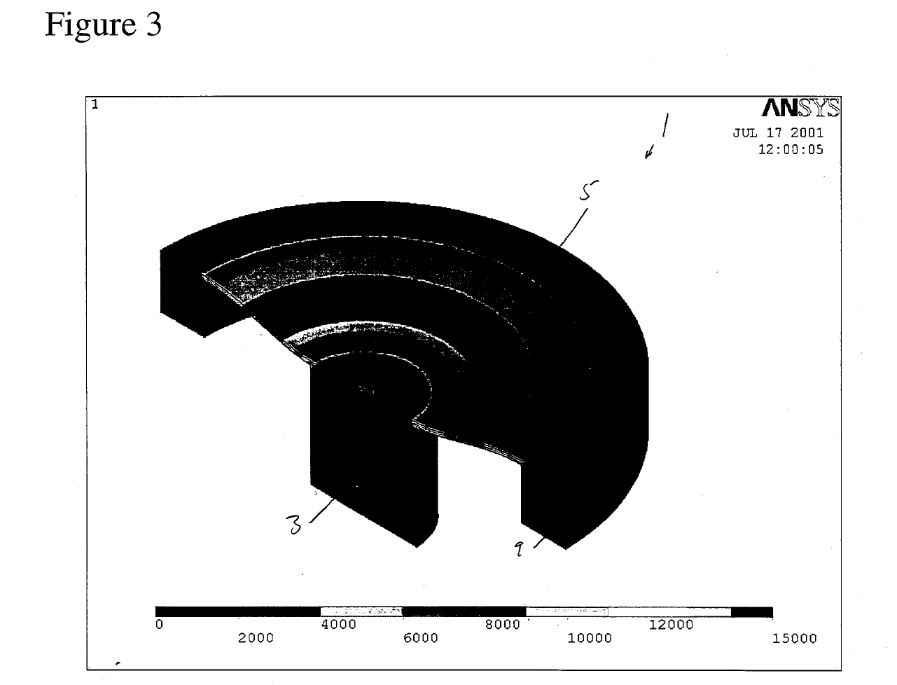

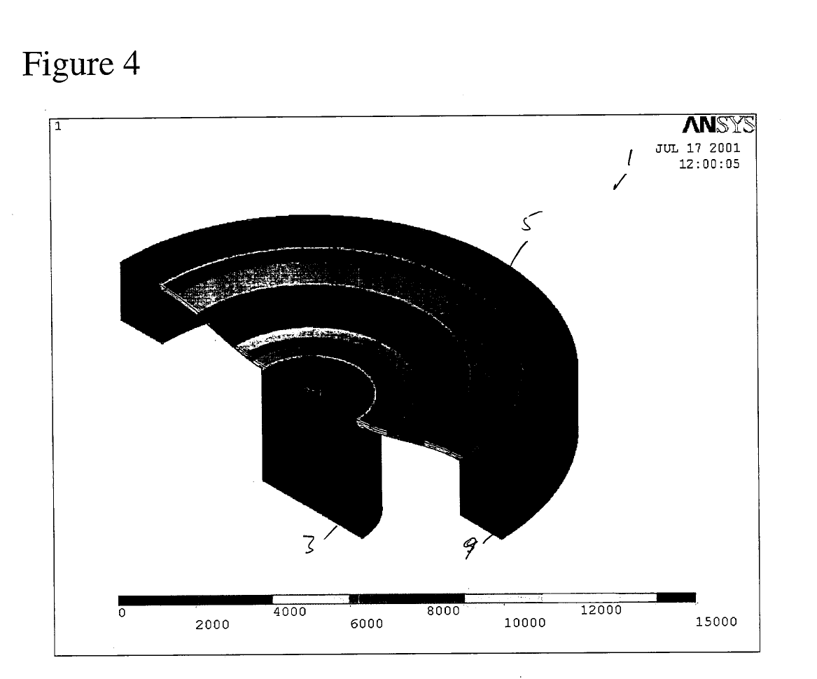

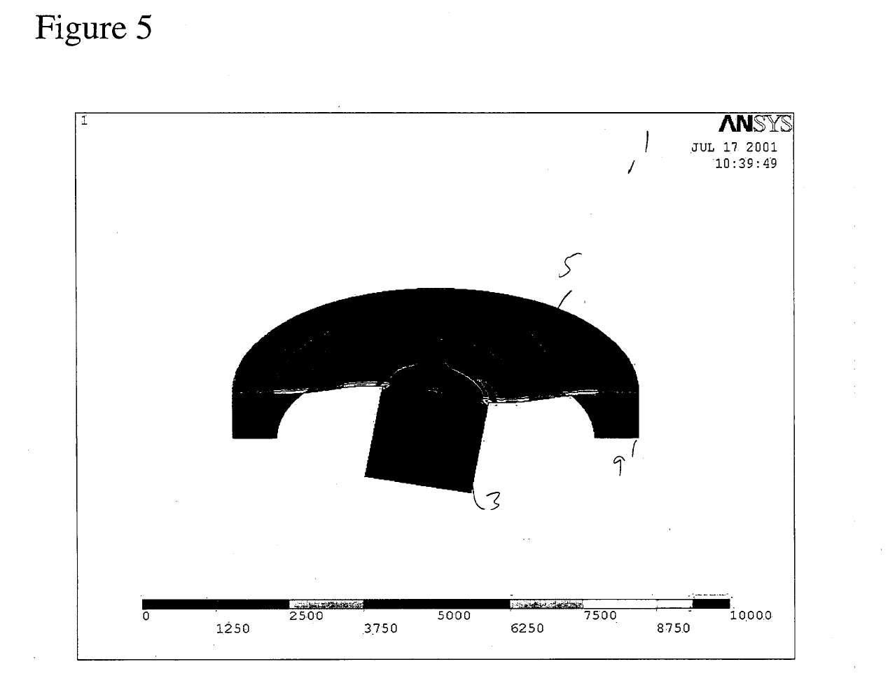

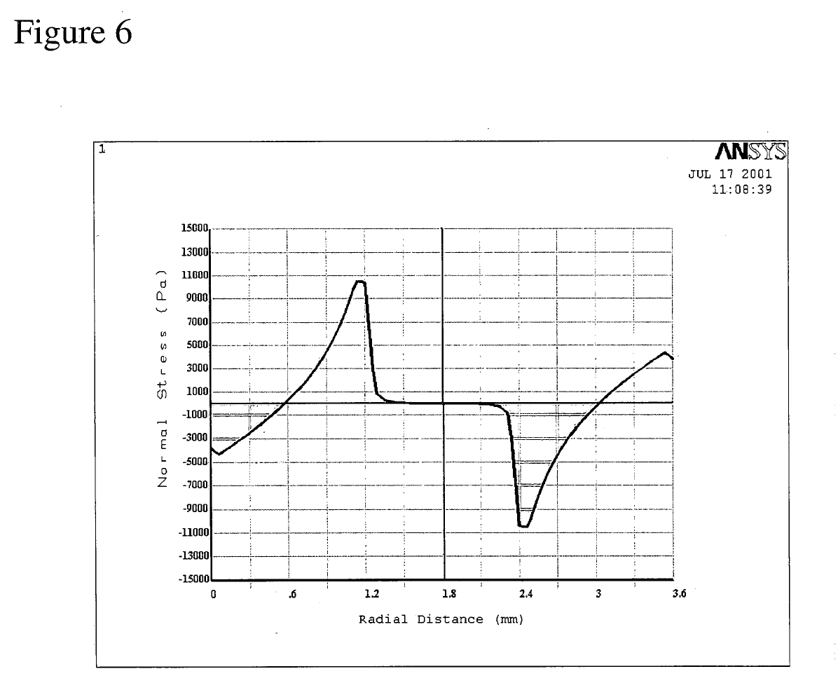

These structures can be easily manufactured from SOI (silicon-on-insulator) wafers. The central block mass can be simply made from the substrate itself. A fabrication process will be described in detail below. If a longer mass block is required, additional silicon or glass can be attached to the original proof mass through a wafer bonding technique. The major fabrication process to create this 3D sensing structure is deep reactive ion etching (DREE) from the backside of a SOI wafer. After a circular trench is carved on the backside by DREE, the circular membrane and the cylindrical proof mass are all formed at the same time through this one step etching. In application, the outer frame of the die is mounted with the tested surface. Whenever there is vibration, the inertial force on the proof mass will cause the circular membrane to deform and therefore, stress the piezoelectric film. The central proof mass will faithfully follow the vibration excitation, and when the membrane is stressed, electric charge will be generated in the piezoelectric film in the stressed area. The behaviors of the sensing structure to the stimulation of a single axis acceleration are used to assist in the derivation of an algorithm to retrieve the three orthogonal acceleration components. FIG. 3 demonstrates the deformation and stress field caused by acceleration normal to the membrane surface (Z direction), and FIG. 4 is the radial stress distribution along a diameter on the membrane. Clearly, the stress is concentrated near the two ends of the membrane, and the stresses are opposite in the area of two ends. Due to the axisymmetric stress distribution, the electric outputs from the inner four pads are the same, and this condition is held for the inner four pads. When vibration occurs in the plane of the membrane, the inertial force in the proof mass will introduce torque load in the membrane. The stress generated by this torque is fully anti-symmetric about the orthogonal direction to the acceleration. FIG. 5 illustrates the response to a pure transverse (X direction) acceleration, and FIG. 6 shows the stress distribution along a diameter on the membrane in the X direction. In this case, the deformation and stress distribution is anti-symmetric about the Y axis. The high stressed areas are still around the two ends of the membrane. For a Y direction acceleration, essentially the same situation will occur, but the deformation and the stress fields are rotated 90° compared to the previous case.

When all three acceleration components exist, one has to determine the electrode combination schemes necessary to retrieve the three acceleration components. In conjunction therewith, a new electronic amplifier can be implemented to fulfill signal conditioning. Table 1 below summarizes the aforementioned discussions and analyses, and the polarities of the electrode pads are provided.

This design holds a distinct advantage over the traditional triaxial sensor in terms of cost and volume. A traditional triaxial accelerometer is usually manufactured by three individual sensors mounted orthogonally to each other. Usually, it is difficult to manufacture the precise electrode pattern, shown in FIG. 2, and align them well with the center block mass by traditional manufacturing techniques. With MEMS fabrication, however, a microelectronic lithographic machine can easily translate any complicated 2D pattern to a wafer in a repeatable, precise and fast way.

TABLE 1
The output polarities of each electrode pad correspondent to single axis
acceleration

| Acceleration | Outer Electrode Pads | | | | Inner Electrode Pads | | | |
|---|---|---|---|---|---|---|---|---|
| Input | 1 | 2 | 3 | 4 | 5 | 6 | 7 | 8 |
| X Direction | — | 0 | + | 0 | + | 0 | — | 0 |
| Y Direction | 0 | + | 0 | — | 0 | — | 0 | + |
| Z Direction | + | + | + | + | — | — | — | — |

From Table 1, one can derive the formulae that will calculate the three orthogonal accelerations:

Ax=(S3+S5)−(S1+S7) (1)

Ay=(S2+S8)−(S4+S6) (2)

Az=(S1+S2+S3+S4)−(S5+S6+S7+S8) (3)

where: Si is the electric output from I^{th} electrode pad, typically measured in pico-coulombs of electric charge per acceleration input, i.e., pC/g.

Transverse sensitivity is a critical parameter for a triaxial sensor. And the transverse responses of this new design can be analyzed based on the equations (1), (2), (3) and the electrode output in Table 1 as follows:

If only Z direction acceleration exists, the electric outputs from the electrodes have the following relations: S1=S2=S3=S4 and S5=S6=S7=S8 (symmetric stress distribution along a diameter line, see FIG. 4). Substituting these relationships into equation (1) and (2), one obtains Ax=0 and Ay=0.

If only X direction acceleration is applied, the electric outputs of the electrodes have the following relations: S3=−S1,S5=−S7 and S2=S4=S6=S8=0 (anti-symmetric along a diameter line, see FIG. 6)

Substituting these relations into equation (2) and (3), it follows that Ay=0 and Az=0. Similarly, when only Y direction acceleration is applied, the transverse pick-ups of X and Z directions are Ax=0 and Az=0.

Therefore, in theory, there are no transverse pick-ups among the three orthogonal X, Y, and Z sensing directions. In practice, because of the geometric tolerance in the sensing structure and the alignment error between the electrodes and the circular membrane, the transverse sensitivities could not be as ideal as zero. Photolithographic technology however, used in the MEMS batch fabrication will provide much tighter tolerance and accurate alignment than traditional manufacturing technologies.

Description of the Structure

An overview of the present invention has been set forth above. Now, two embodiments and a method of making them will be disclosed.

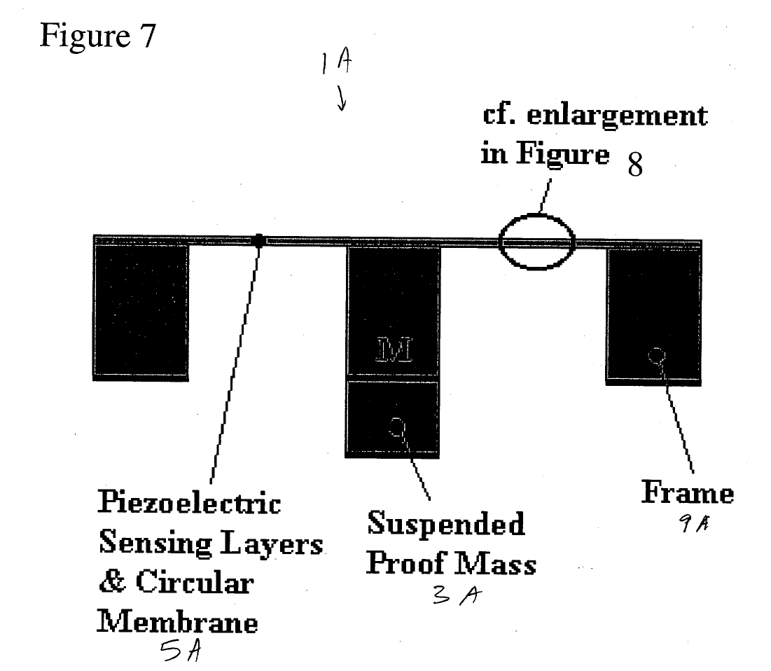

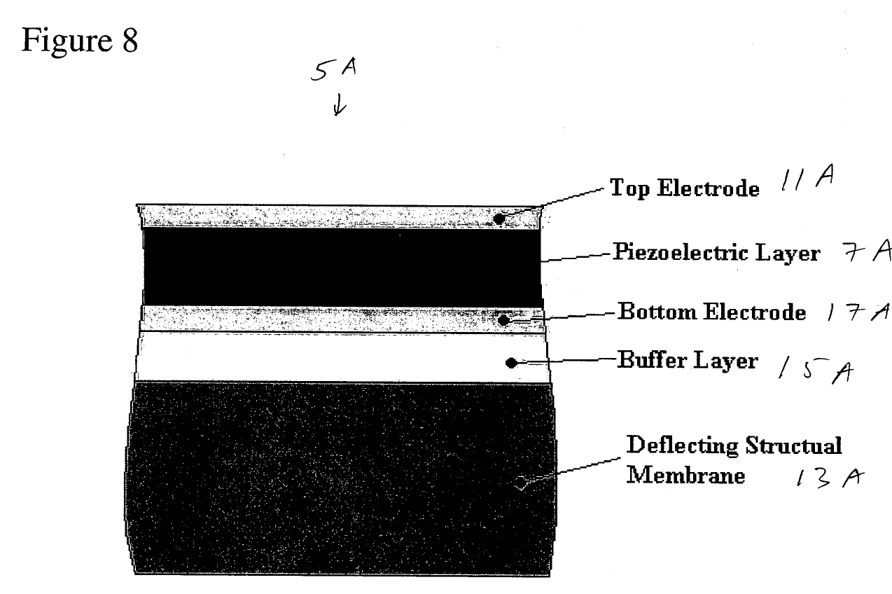

The first embodiment implements the above-described structure 1 as a piezoelectric, circular membrane type inertial sensing structure. The cross section of this embodiment of the structure is illustrated in FIG. 7 as 1A. It has four major components: a central cylindrical proof mass M 3A, a continuous belt-shaped membrane 5A, a piezoelectric sensing layer (not shown in FIG. 7, but to be described below with reference to FIG. 8) deposited on the top of the membrane 5A, and a fixed mounting frame 9A. Obviously, the circular membrane 5A could be altered to other different shapes, e.g. an ellipse.

The detailed layout of the membrane 5A is shown in FIG. 8. The bottom supporting membrane 13A is directly made from the substrate, and it will carry the mechanical load from the inertial mass M 3A. Moreover, it will deflect whenever an inertial load is introduced in the proof mass. Above the structural membrane layer 13A is a buffer layer 15A, which will provide reliable adhesion to the metallic electrode and will also prevent the piezoelectric layer from diffusing into the substrate layer. On top of the buffer layer 15A is a piezoelectric layer 7A which is sandwiched by a bottom electrode 17A and top electrodes 11A. Any deformation in the supporting membrane will cause the piezoelectric layer to be stressed, consequently generating electric charge. This electric signal is then collected by the conductive electrodes and fed to an electronic conditioner.

Fabrication Method

The fabrication technique involved in manufacturing this sensor is based on the microelectromechanical system (MEMS) batch processing technology, which has been evolving from silicon integrated circuit fabrication. This new technology facilitates mass production of miniature, sophisticated microelectromechanical devices, and it also guarantees high accuracy and low manufacturing cost. Moreover, the associated electronic conditioner can be integrated on the same substrate, which will further miniaturize sensor systems and improve their reliability.

The fabrication processes for this sensing structure is as follows. First, a bare silicon (Si) (or other suitable material) wafer—SOI (silicon-on-oxide) wafer preferable—is processed to form the buffer layers, usually consisting of SiO₂ layers on its surfaces. Then, the bottom electrode is deposited on the front side of the wafer over the buffer layer. In the present illustrative example, Pt/Ti is utilized. Next, the piezoelectric layer is deposited on top of the bottom electrode layer by means of the sol-gel process. Lead zirconate titanate (PZT) is selected as the sensing material in our prototype due to its exceptional piezoelectric properties. Finally, a top metallic electrode is placed above the piezoelectric film. To this point, the wafer has been prepared as a composite, multiple layered substrate as shown in FIG. 8, and it is now ready for sensing structure fabrication. Surface micromachining is then applied to fabricate the front side of the sensor. First, the top electrode is patterned by means of lithographic technique and chemical or physical etching. Later, some windows are opened through the piezoelectric layer in order to provide access to the bottom electrode. This is achieved by lithography and chemical or ion milling etching. After the front side processing is completed, the 3D sensing structure is sculptured through backside deep etching. This etching creates a deep circular trench and produces a prismatic mass block and circular shape membrane. In fact, both the mass block and the membrane are part of the Si substrate. If a longer mass is required in order to achieve a higher transverse inertial load, an extra substrate block can be bonded to the cylindrical proof mass by a variety of wafer bonding techniques.

By way of comparison to the state-of-the-art MEMS fabrication technology, traditional manufacturing techniques could also be used to make this type of sensing structure. It will be extremely difficult, however, to assemble this complicated, miniature sensor, while maintaining a very tight tolerance and consistency. In terms of cost, the MEMS batch processing is ideally suited for mass production and has an unprecedented economical advantage.

Several advantages are inherent in this design. Because this type of sensing structure is fully enclosed, no opened area is required from the backside to the front side of a substrate. Consequently, the fabrication process is greatly simplified compared with the fabrication of other beam type structures. Meanwhile, since the whole thickness of the wafer is utilized as the proof mass, a large inertial mass can be easily achieved, implying that the performance of this type of sensing structure can outperform that of the surface micromachined beams. Furthermore, since a continuous membrane is used as a supportive spring, a shock resistant, robust sensor is produced.

Uniaxial Accelerometer

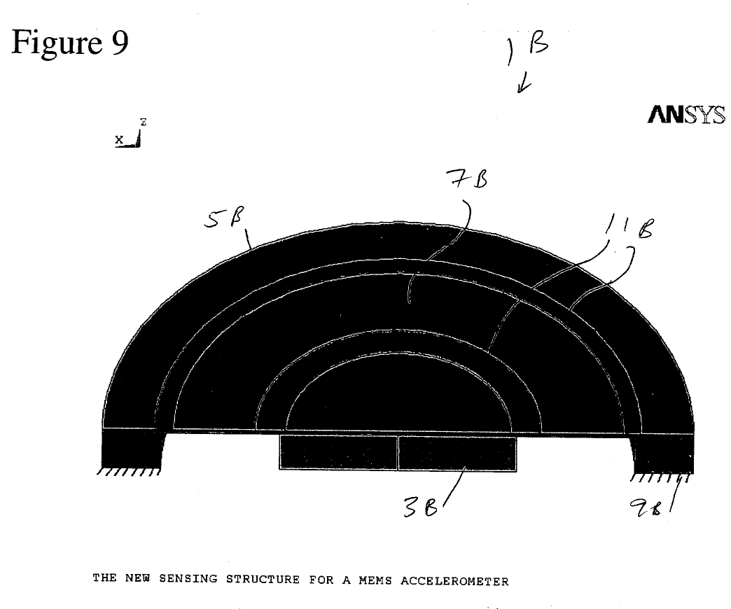

In the previous embodiment, a triaxial accelerometer constructed from an aforementioned sensing structure was presented. Actually, with little variation, this sensor can be converted into a uniaxial accelerometer. Instead of a quadrant placement of four electrode sections near the inner and outer ends of the membrane, one just simply replaces them with two continuous circular ring shape electrodes 11B. The result is a uniaxial accelerometer. FIG. 9 illustrates the configuration of this layout 1B, including the proof mass M 3B, the membrane 5B, the piezoelectric layer 7B, the frame 9B and the top electrodes 11B.

When acceleration normal to the membrane surface is applied, the proof mass M will move up and down accordingly with the vibration input, and the induced stress fields near both ends of the membrane are axisymmetric. Therefore, electric charge will be generated on each electrode ring as they reflect the acceleration level in the normal direction. In the case where transverse acceleration is exerted on the sensor, the inertial load of the proof mass will bend the circular membrane, and the corresponding stress field is antisymmetric to the diameter normal to the acceleration direction. As a result, the net charge generated on each electrode ring is zero. Therefore, this type of electrode layout is immune to the transverse acceleration. In summary, the sensing structure described herein is suitable for either triaxial or uniaxial accelerometer design.

While two preferred embodiments and a method of making them have been disclosed, those skilled in the art who have reviewed the present disclosure will readily appreciate that other embodiments can be realized within the scope of the invention. For example, disclosures directed to specific materials or intended uses are intended as illustrative rather than limiting. Also, a biaxial sensor could be implemented, in which case the electrodes could be reconfigured accordingly. Therefore, the present invention should be construed as limited only by any claims that are filed in connection herewith or in any application claiming the benefit hereof. It is the intention of the applicant to claim all disclosed embodiments, with no such disclosed embodiments being deemed dedicated to the public.

I claim:

1. A sensing structure comprising:
a central block proof mass;
a membrane to which the central block proof mass is attached;
a piezoelectric sensing layer on the membrane; and
a plurality of electrodes in contact with the piezoelectric sensing layer for receiving an electrical output of the piezoelectric sensing layer.

2. The sensing structure of claim 1, wherein the plurality of electrodes comprise:
at least one bottom electrode; and
a plurality of top electrodes arranged to receive, from the electrical output of the piezoelectric sensing layer, signals representing acceleration experienced by the central block proof mass in at least one direction.

3. The sensing structure of claim 1, further comprising a mounting frame to which the membrane is attached.

4. A method of making a sensing structure, the method comprising:
(a) providing a substrate;
(b) processing the substrate to form a buffer layer;
(c) depositing a bottom electrode layer on the buffer layer;
(d) depositing a piezoelectric layer on the bottom electrode layer;
(e) depositing a top electrode layer on the piezoelectric layer;
(f) processing the top electrode layer and the piezoelectric layer to form a top electrode pattern and to provide an access window through the piezoelectric layer to the bottom electrode layer; and
(g) processing the substrate to form a mass block and a membrane.

5. The method of claim 4, wherein step (g) comprises processing the substrate to form a mounting frame.

6. The method of claim 4, further comprising (h) attaching an additional mass to the mass block.

7. The method of claim 4, wherein step (d) is performed through a sol-gel process.

8. The method of claim 4, wherein step (f) is performed through chemical or physical etching.

9. The method of claim 4, wherein step (g) is performed through backside deep etching.
